(19) United States
(12) Patent Application Publication
(10) Pub. No.: US 2016/0275796 A1
(43) Pub. Date: Sep. 22, 2016

(54) VEHICLE, SERVER AND VEHICLE MONITORING SYSTEM HAVING THE SAME

(71) Applicant: HYUNDAI MOTOR COMPANY, Seoul (KR)

(72) Inventors: Sung Un KIM, Yongin-si (KR); Ki Dong KANG, Seoul (KR); Kyunghyun KANG, Suwon-si (KR); Heejin RO, Seoul (KR); Seok-young YOUN, Seoul (KR); Bitna BAEK, Seoul (KR); Ga Hee KIM, Suwon-si (KR); Jong Hyuck HEO, Yongin-si (KR); Chisung KIM, Seoul (KR)

(21) Appl. No.: 14/958,926

(22) Filed: Dec. 3, 2015

(30) Foreign Application Priority Data
Mar. 19, 2015 (KR) 10-2015-0038447

(51) Int. Cl. G08G 1/16; H04N 7/18; G06K 9/00

(52) U.S. Cl. CPC G08G 1/163; G08G 1/166; G06K 9/00805; H04N 7/181

(57) ABSTRACT

A vehicle includes an image acquisition unit for acquiring an image about a surrounding of the vehicle, a travelling information acquisition unit for acquiring travelling information about the vehicle, a communication unit for transmitting the information acquired from the travelling information acquisition unit to a server and receiving information about an event related to the travelling of the vehicle from the server, and a control unit for notifying a driver of a possible change in a travelling environment of the vehicle according to the event based on the information about the event received from the communication unit.

### CROSS-REFERENCE TO RELATED APPLICATION

This application claims the benefit of priority to Korean Patent Application No. 10-2015-0038447, filed on Mar. 19, 2015 with the Korean Intellectual Property Office, the disclosure of which is incorporated herein by reference.

### TECHNICAL FIELD

Embodiments of the present disclosure relate to a vehicle, a server that monitors travelling of a vehicle and a vehicle monitoring system having the same.

### BACKGROUND

As vehicles are widely used and become indispensable in everyday life, vehicle accidents may also increase. In order to prevent a loss of lives and property due to vehicle accidents, vehicle technologies are being developed toward ensuring driver safety, different from technologies developed in the past which focused on vehicle functionality.

In recent years, there have been continuous attempts to integrate vehicle technologies with information and communication technologies that have been rapidly developed for use on portable multimedia apparatuses including smart phones, so as to ensure safe driving.

### SUMMARY OF THE DISCLOSURE

Therefore, it is an aspect of the present disclosure to provide a vehicle capable of preventing a vehicle accident by analyzing an event that occurs during a traveling of the vehicle, a server and a vehicle monitoring system having the same.

Additional aspects of the disclosure will be set forth in part in the description which follows and, in part, will be obvious from the description, or may be learned by practice of the disclosure.

In accordance with an embodiment of the present disclosure, a vehicle includes an image acquisition unit, a travelling information acquisition unit, a communication unit and a control unit. The image acquisition unit may be configured to acquire an image about a surrounding of the vehicle. The travelling information acquisition unit may be configured to acquire travelling information about the vehicle. The communication unit may be configured to transmit the information acquired from the travelling information acquisition unit to a server and receive information about an event related to the travelling of the vehicle from the server. The control unit may be configured to notify a driver of a possible change in a travelling environment of the vehicle according to the event based on the information about the event received from the communication unit.

The image acquisition unit may include a camera that is provided to acquire an image in front of the vehicle, an image behind the vehicle, an image of a left side of the vehicle and an image of a right side of the vehicle.

The traveling information acquisition unit may include at least one of a speed of the vehicle, an acceleration of the vehicle, a steering angle of the vehicle, a position of the vehicle and a distance between the vehicle and a nearby vehicle adjacent to the vehicle.

The traveling information acquisition unit may include at least one of a speed sensor to sense a speed of the vehicle, an acceleration sensor to sense an acceleration of the vehicle, a steering angle sensor to sense a steering angle of the vehicle, a ultrasonic sensor or a radar sensor to sense an object around the vehicle, and a global positioning system (GPS) apparatus to detect a position of the vehicle.

The vehicle may further include an image processing unit configured to acquire information about an object around the vehicle from the image acquired from the image acquisition unit.

The image processing unit may acquire the information about the object around the vehicle by detecting the object around the vehicle from the image acquired from the image acquisition unit and calculating a position or a speed of the detected object.

The communication unit may transmit the image acquired by the image acquisition unit and the information acquired from the image by the image processing unit.

The communication unit may exchange information with the server by using third generation (3G) communication technology, fourth generation (4G) communication technology and fifth generation (5G) communication technology.

The control unit may control at least one of an audio system, a navigation system, an instrument panel, a steering wheel, a safety belt, and a seat of the vehicle such that the driver is notified of a risk of the vehicle accident occurring due to the event in a visual, audible or tactile manner.

The control unit may control at least one of an audio system of the vehicle, a navigation system of the vehicle or an instrument panel of the vehicle if a time remaining until a vehicle accident expected time included in the information about the event is equal to or larger than a first reference time to notify the driver of a risk of the vehicle accident through a speed or an image so that the driver avoids the vehicle accident.

The control unit may control the audio system, the navigation system, the instrument panel, a steering wheel, a safety belt or a seat if the time remaining until the vehicle accident expected time is equal to or smaller than a second reference time that is smaller than the first reference time to notify the driver of a risk of the vehicle accident through a warning sound, a warning image or vibration.

The control unit may control the steering wheel or a brake of the vehicle if the time remaining until the vehicle accident expected time is equal to or smaller than a third reference time that is smaller than the second reference time.

In accordance with another embodiment of the present disclosure, a server includes a memory, a communication unit and a processor. The memory may be configured to store data about an event related to vehicle travelling. The communication unit may be configured to receive information transmitted from vehicles and to transmit information about the event related to vehicle travelling to a target vehicle. The processor may be configured to determine vehicles that arrive at the target vehicle within a predetermined time based on the information transmitted from the vehicles, compare the information transmitted from the determined vehicles with the data stored in the memory and generate information about the event related to vehicle travelling.

The memory may store data related to an event that has caused a vehicle accident or an event whose chance of causing a vehicle accident is equal to or higher than a predetermined reference.

The processor may determine whether the target vehicle has had an event related to a vehicle accident by comparing the data stored in the memory with the information transmitted from the determined vehicles, and calculate a chance of a vehicle accident occurring due to the event.

The processor may calculate a vehicle accident expected time if the chance of having a vehicle accident due to the event is equal to or higher than the predetermined reference, wherein the communication unit may transmit information about the event including the vehicle accident expected time calculated by the processor to the target vehicle.

The processor may generate the information about the event related to vehicle travelling by using the information transmitted from the vehicles, information about weather and information about real time traffic condition.

The communication unit may exchange information with the vehicle by using third generation (3G) communication technology, fourth generation (4G) communication technology and fifth generation (5G) communication technology.

In accordance with another embodiment of the present disclosure, a vehicle monitoring system includes a target vehicle and a server. The target vehicle may be configured to transmit information related to vehicle travelling to a server. The server may be configured to receive information transmitted from vehicles including the target vehicle, determine vehicles that arrive at the target vehicle within a predetermined time based on the information transmitted from the vehicles, compare the information transmitted from the determined vehicles with previously stored data about an event related to vehicle travelling to generate information about the event related to vehicle travelling, and transmit the generated information to the target vehicle. The target vehicle may receive the information about the event transmitted from the server and notify a driver of a possible change in a travelling environment of the vehicle according to the event based on the received information about the event.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating an external appearance of a vehicle in accordance with an embodiment of the present disclosure;

FIG. 2 is a view illustrating a configuration of an interior of a vehicle in accordance with an embodiment of the present disclosure;

FIG. 3 is a block diagram illustrating a configuration of a vehicle monitoring system in accordance with the disclosed embodiment of the present disclosure;

FIG. 4 is a view illustrating a large-scale antenna of a base station according to a 5G communication scheme in accordance with an embodiment of the present disclosure;

FIGS. 5A to 5C are views illustrating a network according to a 5G communication scheme in accordance with an embodiment of the present disclosure;

FIG. 6 is a block diagram illustrating a configuration of a server in accordance with a disclosed embodiment of the present disclosure;

FIGS. 7 to 9 are diagrams conceptually illustrating a method of a vehicle notifying a driver of a risk of a vehicle accident in accordance with a disclosed embodiment of the present disclosure; and

FIG. 10 is a flow chart showing a method of monitoring an event of a vehicle in accordance with a disclosed embodiment of the present disclosure.

### DETAILED DESCRIPTION

Reference will now be made in detail to the embodiments of the present disclosure, examples of which are illustrated in the accompanying drawings, wherein like reference numerals refer to like elements throughout.

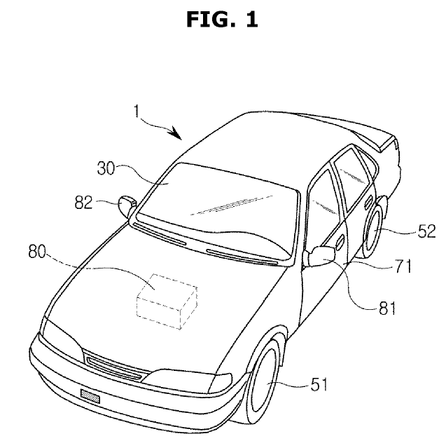

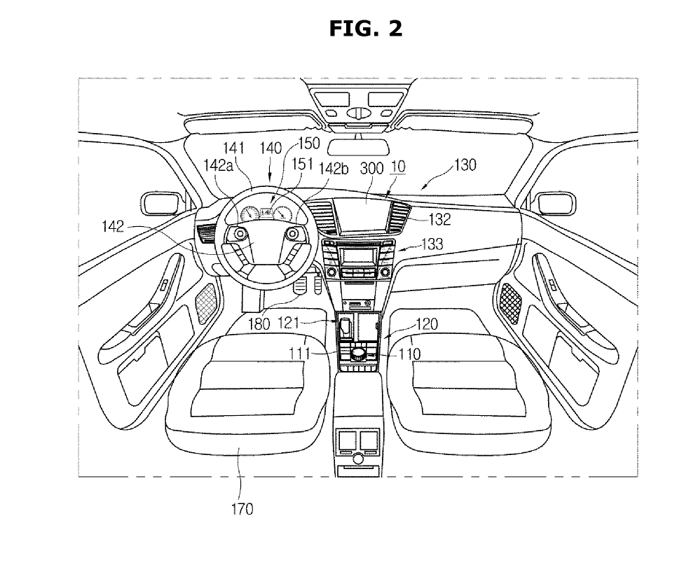

FIG. 1 is a view illustrating an external appearance of a vehicle in accordance with an embodiment of the present disclosure, and FIG. 2 is a view illustrating a configuration of an interior of a vehicle in accordance with an embodiment of the present disclosure.

Referring to FIG. 1, a vehicle 100 in accordance with an embodiment of the present disclosure includes a vehicle body 1 forming an external appearance of the vehicle 100, wheels 51 and 52 to move the vehicle 100, a driving apparatus 80 to rotate the vehicle wheels 51 and 52, doors 71 to seal the interior of the vehicle from the exterior, a front glass 30 to provide a driver at an inside of the vehicle with a front view of the vehicle 100 and side mirrors 81 and 82 to provide the driver with a rear view of the vehicle 100.

The vehicle wheels 51 and 52 include rear wheels 51 provided at a front side of the vehicle 100 and rear wheels 52 provided at a rear side of the vehicle 100.

The driving apparatus 80 provides a rotary power to the front wheels 51 or the rear wheels 52 such that the vehicle body 1 moves forward or backward. The driving apparatus 60 includes an engine to generate a rotary power by combusting fossil fuel or a motor to generate a rotary power by receiving power from a condenser.

The door 71 is rotatably provided at a left side and a right side of the vehicle body 1, so as to allow a driver to get in the vehicle 100 upon being opened, and allow the interior of the vehicle 100 to be shield from the outside upon being closed.

The front glass 30 referred to as windshield glass is provided at an upper portion of the front side of the vehicle body 100. A driver in the vehicle 100 may view a front of the vehicle 100 through the front glass 30. In addition, side mirrors 81 and 82 include a left side mirror 81 and a right side mirror 82 that are provided at a left side and a right side of the vehicle body 1, respectively. The driver in the vehicle 100 may view sides of the vehicle 100 and a rear of the vehicle 100 through the side mirrors 81 and 82.

In addition, the vehicle 100 may include various sensors that sense an obstacle at a surrounding of the vehicle 100 such that a driver recognizes a surrounding environment of the vehicle 100. In addition, the vehicle 100 may include various sensors to sense traveling information such as vehicle speeds. Details of travelling information about the vehicle 100 and the various sensors to sense the surrounding environment of the vehicle 100 will be described later.

Referring to FIG. 2, the vehicle 100 may include a dashboard on which a gearbox 120, a center fescia 130, a steering wheel 140 and an instrument panel 150 are provided.

The gear box 120 may be provided with a gear lever 121 installed thereon to change speed of the vehicle. As shown in the drawing, the gear box is provided with a dial manipulation part 111 provided to control functions of multimedia apparatuses including a navigation apparatus 10 or an audio system 133 or to control main functions of the vehicle 100, and is provided with an input apparatus 10 including various buttons.

An air conditioning apparatus 132, the audio system 133 and the navigation apparatus 10 may be installed on the center fascia 130.

The air conditioning apparatus 132 adjusts the temperature, humidity, and cleanliness of air at the inside of the vehicle 100 and the flow of air at the inside of the vehicle to maintain a pleasant atmosphere in the vehicle 100. The air conditioning apparatus 132 may include at least one vent that is installed at the center fascia 130 to discharge air. Buttons or a dial may be installed on the center fascia 130 to control the air conditioning apparatus 132. A user such as a driver may control the air conditioning apparatus of the vehicle by using the button or dial disposed on the center fascia 130. Alternatively, the user may control the air conditioning apparatus by using the buttons of the input apparatus 110 or the dial manipulation part 111 that are installed on the gear box 120.

According to an embodiment of the present disclosure, the navigation apparatus 10 may be installed on the center fascia 130. The navigation apparatus 10 may be buried in the center fascia 130 of the vehicle 100. According to an embodiment of the present disclosure, an input part may be installed on the center fascia 130 to control the navigation apparatus 10. According to an embodiment of the present disclosure, an input of the navigation apparatus 10 may be installed on a position except for the center fasica 130. For example, the input part of the navigation apparatus 10 may be formed around a display part 300 of the navigation apparatus 10. In addition, the input part of the navigation apparatus 10 may be installed on the gear box 120.

The steering wheel 140 is an apparatus configured to control a running direction of the vehicle 100, and includes a rim 141 grasped by a driver and a spoke 142 connected to a steering apparatus of the vehicle 100 and connecting the rim 141 to a hub of a rotating shaft for steering. According to an embodiment of the present disclosure, the spoke may be provided with various apparatuses, for example, manipulation apparatuses 142a and 142b to control various apparatuses in the vehicle 100, for example, an audio system. The steering wheel may serve to call a driver's attention such that driving safety is ensured. For example, the steering wheel may warn a driver of drowsy driving in a tactful manner through vibration, and upon occurrence of a risk of an accident due to change in a travelling environment, may warn a driver of the risk through vibration.

In addition, the dashboard may be provided with various instrument panels 150 to display driving speeds, revolutions per minute (RPM) of an engine or the amount of fuel remaining. The instrument panel 150 may include an instrument panel display 151 to display a state of the vehicle, information related to running the vehicle and information related to manipulation of multimedia apparatuses.

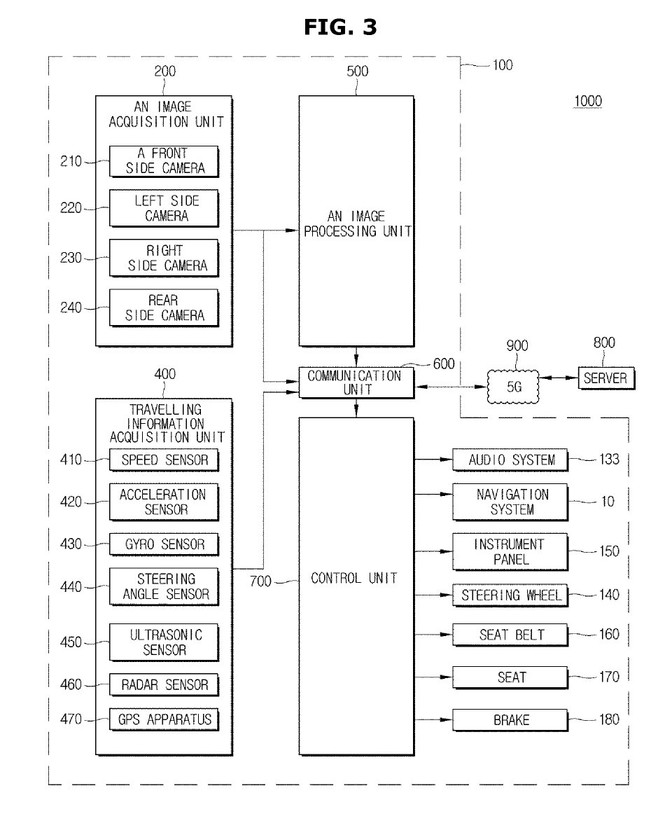

The driver may drive the vehicle 100 by manipulating the various apparatuses described above. The vehicle 100 may be provided with various sensors to sense information from outside of the vehicle 100 required for the vehicle 100 to run or travelling information about the vehicle 100, in addition to the apparatuses that may be manipulated by a driver for driving the vehicle 100. The disclosed embodiment provides a server 800 configured to receive various types of information acquired from various sensors provided on the vehicle 100 to recognize whether an event that occurs at a surrounding of the vehicle 100 may cause a vehicle accident in real time, and to notify the vehicle 100 of a risk of an accident. In addition, the disclosed embodiment provides the vehicle 100 configured to transmit information related to driving the vehicle 100 to the server 800, and to notify a driver of a risk of an accident of the vehicle. In addition, the disclosed embodiment provides a vehicle monitoring system 10 including the vehicle 100 and the server 800. In the following description, a vehicle to be monitored will be referred to as a target vehicle, and vehicles except for the target vehicle will be referred to as other vehicles. Hereinafter, referring to FIGS. 3 to 7, the vehicle monitoring system 1000 according to the disclosed embodiment will be described in detail.

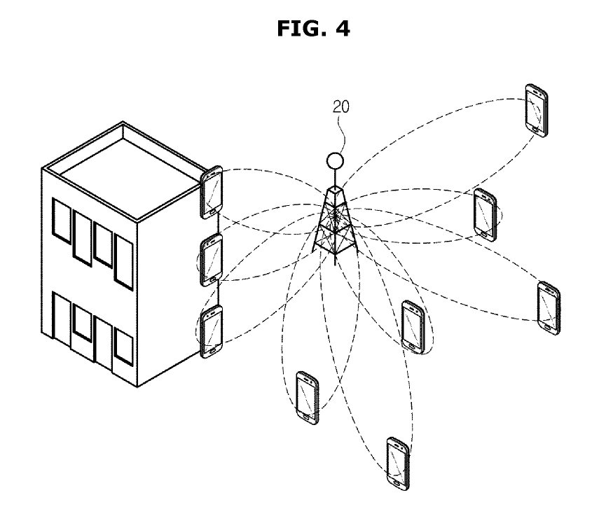

FIG. 3 is a block diagram illustrating a configuration of a vehicle monitoring system in accordance with the disclosed embodiment of the present disclosure, and FIG. 4 is a view illustrating a large-scale antenna in a base station according to a 5G communication scheme.

Referring to FIG. 3, a target vehicle according to the disclosed embodiment includes an image acquisition unit 200 to acquire an image of an outside of the target vehicle 100, a travelling information acquisition unit 400 to acquire travelling information about the target vehicle 100, a communication unit 600 to transmit information acquired from the image acquisition unit 200 and the travelling information acquisition unit 400 to the server 800, an image processing unit 500 to perform an image processing on the image acquired from the image acquisition unit 200 and a control unit 700 to control the audio system 133 and a navigation system 10 to notify a chance of having a vehicle accident due to an event that may occur while driving of the vehicle 100.

The image acquisition unit 200 includes a front side camera 210 to acquire an image in front of the target vehicle 100, a left side camera 220 and a right side camera 230 to acquire images of left side and right side of the target vehicle 100, and a rear side camera 240 to acquire an image behind the target vehicle 100. The position or the number of cameras are not limited as long as images in front of/behind/side of the target vehicle 100 are acquired. The camera may include a charge-coupled device (CCD) image sensor or a complementary metal oxide semiconductor (CMOS) image sensor.

The image acquisition unit 200 is provided to acquire information about an outside of the target vehicle 100 whereas the travelling information acquisition unit 400 is provided to acquire information related to driving the target vehicle 100.

The travelling information acquisition unit 400 includes a speed sensor 410 to sense the speed of the target vehicle 100, an acceleration sensor 420 to sense acceleration of the target vehicle 100, a gyro sensor 430 to sense an angular velocity of the target vehicle 100, a steering angle sensor 440 to detect a steering angle of a steering wheel, an ultrasonic sensor 450 or a radar sensor 460 to sense an object at an outside of the target vehicle 100, for example, another vehicle or another person, and a global positioning system (GPS) apparatus 470 to detect the position of the target vehicle 100.

The speed sensor 410 may include a wheel speed sensor to sense wheel speeds of wheels. In addition, the speed sensor 410 may include the navigation apparatus 10 that calculates the speed of the vehicle 100 based on position information of the target vehicle 100 and informs a user of the calculated speed of the vehicle.

The acceleration sensor 420 detects information about a linear motion of the target vehicle 100. In detail, the acceleration sensor 420 may detect a linear acceleration and a linear displacement of the target vehicle 100 by using Newton's Second Law (Law of Acceleration). The acceleration sensor 420 may be provided using a piezoelectric acceleration sensor, a capacitive sensor acceleration sensor, and/or a strain gauge acceleration sensor. The piezoelectric acceleration sensor includes a piezoelectric element that outputs an electric signal by mechanical deformation, and detects an acceleration by using an electrical signal being output from the piezoelectric element. In detail, the piezoelectric acceleration sensor detects an electrical signal being output from a piezoelectric element by deformation of a piezoelectric element due to acceleration, and calculates an acceleration from the detected electric signal. The capacitive acceleration sensor detects acceleration, upon change in a distance with respect to a structure, by using change in the capacitance due to the change in the distance. In detail, the capacitive acceleration sensor includes a movable structure and a fixed structure, and detects as a change in a capacitance from a change in a distance between the structures according to an inertial force, and calculates an acceleration from the detected change in capacitance. The strain gauge type acceleration sensor detects acceleration by using a strain gauge which exhibits change in an electrical resistance by a mechanical deformation. In detail, the strain gauge acceleration sensor detects change in an electrical resistance from deformation of a structure according to acceleration, and calculates acceleration from the detected change in electrical resistance. In addition, the acceleration sensor may adopt a Micro Electro Mechanical System (MEMS) in which micro mechanical, micro electro and semiconductor processing technologies are merged at micro-sizes.

The gyro sensor 430 is referred to as a gyro scope or an angular sensor, and detects information about rotational movement of the target vehicle 100. In detail, the gyro sensor 430 may detect an angular velocity of rotation of the target to be detected by using law of conservation of momentum, sagnac effect, coriolis effect, etc. The gyro sensor 430 may adopt a gimbal gyrosensor, an optical gyro sensor, and/or a vibration gyro sensor. The gimbal gryosensor detects a rotational movement of a target by using conservation of angular momentum in which a rotating object has a constant center of rotation maintained and by using precession in which when an external force is applied to a rotating body, the rotating body has a center of rotation rotate along an orbit according to gyroscopic reaction moment. The optical gyro sensor detects a rotation movement of a target by using the sagnac effect in which light emitted in a clockwise direction along a circular optical path has different arrival time from that of light emitted in a counter clockwise direction according to rotation of the target. Vibration gyro sensors detects a rotation movement of a target by using a phenomenon that when an object vibrating in a certain direction rotates, the object vibrates in another direction according to the coriolis force. The gyro sensor 430 may adopt a micro electro mechanical system (MEMS) sensor. For example, a capacitive gyro sensor, one of the MEMS gyro sensors, detects a change in capacitance from deformation of a micro mechanical structure according to coriolis force that is proportionate to a rotation speed and calculates the rotation speed from the change in capacitance.

The acceleration sensor 420 and the gyro sensor 430 may be provided separately from each other, or may be integrally formed with each other.

Data related to driving of the target vehicle 100, acquired by the travelling information acquisition unit 400 and an image acquired by the image acquisition unit 200 may be transmitted to the communication unit 600. In addition, the image acquired by the image acquisition unit 200 may be transmitted to the image processing unit, not only to the communication unit 600.

The image processing unit may receive an image of outside of the target vehicle 100 from the image acquisition unit 200, detect a target object, such as another vehicle or a human, included in the image, and acquire information such as the position or speed of the detected target object. In addition, the image processing unit may convert the image acquired from the image acquisition unit 200 into an image having a resolution that is able to be processed by a processor 820 of the server 800, or into an image having a format that is able to be processed by the processor 820 of the server 800.

The image acquired from the image acquisition unit 200 may be directly transmitted to the server 800 through the communication unit 600. Alternatively, the image processing unit may extract information about a target object included in the image through a predetermined image processing such that the image acquired from the image acquisition unit 200 may be transmitted to the server 800 together with the extracted information, thereby reducing computation load of the server 800. In this manner, the server 800 may rapidly check an event that has occurred at a surrounding of the target vehicle 100, and also rapidly calculate a chance of having a vehicle accident due to the event.

The image processor may store predetermined information desired to be extracted from an image, and may store the type of image processing to be used to extract the information in correspondence to the type of information desired to be extracted.

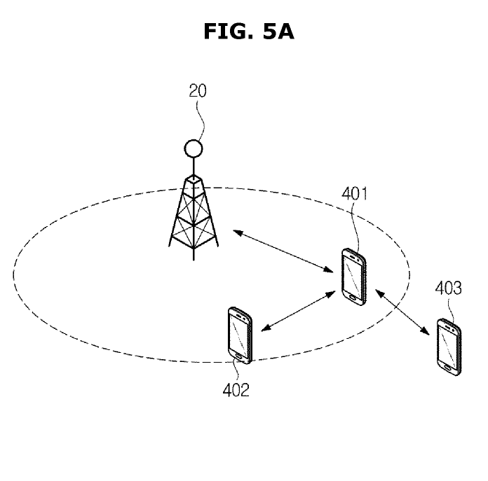

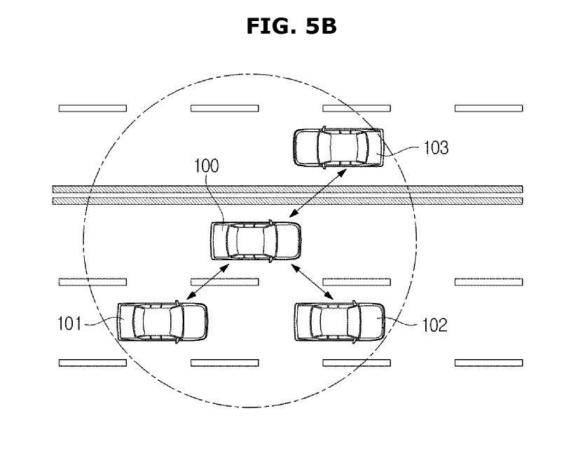

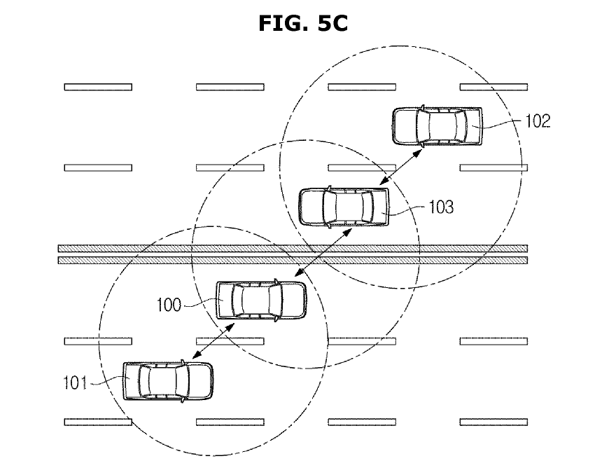

The communication unit 600 may transmit data transmitted from the travelling information acquisition unit 400 and the image acquisition unit 200 to the server 800 through a communication network 900. The communication unit 600 may transmit the image to the server 800 directly from the target vehicle 100, or may transmit information extracted from an image being subjected to a predetermined image processing in the image processing unit to the server 800. The image transmitted from the image acquisition unit 200 may be transmitted to the server 800 together with the information transmitted from the image processing unit. In addition, the communication unit 600 may receive information about an event transmitted from the server 800, and transmit the event to the control unit 700. The communication network 900 for transmission of data may be implemented using third generation (3G) technology and fourth generation (4G) technology that have been previously commercialized, and may be implemented by using fifth generation (5G) technology for more rapid transmitting/receiving information in substantially real time. The communication unit 600 may include an apparatus that supports 3G, 4G and 5G communication methods that are adopted by the communication network 900. The communication unit 600 and the server 800 according to an embodiment of the present disclosure may exchange information through the communication network 900 that adopts 5G communication scheme for almost real time transmission/reception. Hereinafter, the 5G communication scheme will be described in detail with reference to FIGS. 4 and 5.

FIG. 4 is a view illustrating a large-scale antenna of a base station according to a 5G communication scheme in accordance with an embodiment of the present disclosure, and FIGS. 5A to 5C are views illustrating a network according to a 5G communication scheme in accordance with an embodiment of the present disclosure.

The communication unit 600 may transmit and receive wireless signals to and from an apparatus including the server 800 through a communication scheme, such as 3G and 4G, as described above. In addition, the communication unit 600 may transmit and receive wireless signals including data to and from a terminal within a distance from the communication unit 600 through communication schemes, such as Wireless LAN, Wi-Fi, Bluetooth, Zigbee, Wi-Fi Direct (WFD, Ultra wideband (UWB), Infrared Data Association (IrDA), Bluetooth Low Energy (BLE), and Near Field Communication (NFC).

In addition, the communication unit 600 may transmit and receive wireless signals through the 5G communication scheme as described above. The 4G communication scheme uses a frequency range that is equal to or lower than 2 GHz, whereas the 5G communication scheme uses a frequency range of about 28 GHz. However, the frequency band used in the 5G communication scheme is not limited thereto.

The 5G communication scheme may adopt a large-scale antenna system. The large-scale antenna system may represent a system that may cover ultrahigh band frequencies by using several tens of antennas, and may simultaneously transmit and receive a great amount of data through multiple access points. In detail, the large-scale antenna system enables increased propagation in a certain direction by adjusting an arrangement of antenna elements, enabling large data transmission and expanding area that is available for a 5G communication network.

Referring to FIG. 4, a base station 20 may simultaneously transmit and receive data to and from a plurality of devices through the large-scale antenna system. In addition, the large-scale antenna system may reduce noise by minimizing electric waves leaking in an undesired direction, thereby reducing power consumption and improving transmission quality.

In addition, different from the conventional technology in which a transmission signal is modulated through an Orthogonal Frequency Division

Multiplexing (OFDM), the 5G communication scheme according to the present disclosure modulates wireless signals through Non-Orthogonal Multiplexing Access (NOMA), which enables multiple access of a large number of devices while achieving large data transmission/reception.

For example, the 5G communication scheme provides a maximum transmission speed of up to 1 Gbps. The 5G communication scheme supports immersive communication that requires large data transmission, for example, transmission of UHD (Ultra-HD), 3D and hologram. Accordingly, a user may transmit and receive super large data that enables more delicate and immersive effects through the 5G communication scheme, in a more rapid manner.

In addition, the 5G communication scheme may perform real time processing at a response time of 1 ms or less. Accordingly, the 5G communication scheme may support real time service in which a response is made before a user's recognition. For example, the vehicle 100 receives sensor information from various devices while driving, and performs real time processing on the sensor information, thereby providing an autonomous traveling system, and various remote controls. In addition, the vehicle 100 may process sensor information with respect to other vehicles that exist at a surrounding of the vehicle 100 through the 5G communication scheme, and notify a user with a chance of vehicle collision in real time. In addition, information about traffic condition on the surrounding may be provided in real time.

In addition, the vehicle 100 may provide passengers in the vehicle 100 5G with a big data service through seconds-based real time processing and large data transmission. For example, the vehicle analyzes various pieces of web information, SNS information and provides the passengers in the vehicle 100 with customized information suitable for the passengers. For example, the vehicle 100 may collect information about popular restaurants and tourist attractions existing at a surrounding of a running path through big data mining, and provide the collected information in real time, so that the passengers may immediately check various pieces of information related to a region around the running path.

Meanwhile, the 5G communication network may support network densification and large data transmission by subdividing a cell. The cell represents a small region obtained by subdividing a large region to achieve more effective use of frequencies in a mobile communication. In this case, a short-range base station is installed on each cell to support a communication between terminals. For example, a 5G communication network enables the size of a cell to be more reduced and subdivided, forming a two stage structure including a macro cell base station, a distributed small cell base station and a communication terminal.

In addition, the 5G communication network may perform a relay transmission of wireless signals through a multi hop method. For example, referring to FIG. 5A, a first terminal 401 may relay wireless signals that are desired for a third terminal 403 located outside the network of the base station 20 to be transmitted to the base station 20. In addition, the first terminal 401 may relay wireless signals that are desired to be transmitted by a second terminal 403 located inside the network of the base station 20 to the base station 20. As described above, at least one device among devices being able to use the 5G communication network may perform relay transmission through a multi hope method. However, the relay transmission through multi-hop method is not limited thereto. Accordingly, an area supported by the 5G communication network may be expanded and the buffering caused by many users existing in a cell may be removed.

Meanwhile, the 5G communication method may support a device-to-device (D2D) communication that is applicable to the vehicle 100, and a wearable device. The D2D communication represents a communication performed between devices and configured to transmit and receive wireless signals including not only data sensed by a device through a sensor but also various type of data stored in the device. When the D2D communication is used, wireless signals are exchanged without passing through a base station. In addition, since wireless transmission is achieved between devices, unnecessary waste of energy is prevented. In this case, in order for the vehicle 100 and the wearable device to use the 5G communication method, the device needs to be equipped with an antenna. The vehicle 100 may transmit and receive wireless signals to and from other vehicles existing around the vehicle 100 through a D2D communication. For example, referring to FIG. 5B, the vehicle 100 may perform a D2D communication with other vehicles 101, 102 and 103 existing around the vehicle 100. In addition, the vehicle 100 may perform a D2D communication with a traffic information apparatus (not shown) installed on a crossroad.

In addition, referring to FIG. 5C, the vehicle 100 may transmit and receive wireless signals to and from the first vehicle 101 and the third vehicle 103 through a D2D communication, and the third vehicle 103 may transmit and receive data to and from the vehicle 100 and the second vehicle 102 through a D2D communication. That is, a virtual network is formed between a plurality of vehicles 100, 101, 102 and 103 that are located within a range in which a D2D communication is allowable, so that wireless signals are transmitted and received between the vehicles 100, 101, 102 and 103.

Meanwhile, the 5G communication network performs a D2D communication with a device in a farther remote area by expanding a range in which a D2D communication is supported. In addition, the 5G communication network supports a real time processing at a speed of 1ms or below and a high capacity communication of 1 Gbps or above, so that signals including desired data may be exchanged between vehicles while on driving.

For example, the vehicle 100 while driving may access other vehicles existing around the vehicle 100, various servers 800 and systems in real time to exchange data therebetween, and may provide various services through augmented reality by processing the data.

In addition, the vehicle 100 may transmit and receive wireless signals including data via a base station or through a D2D communication, by using a frequency band except for the above described frequency band, and the communication method is not limited to the frequency band described above.

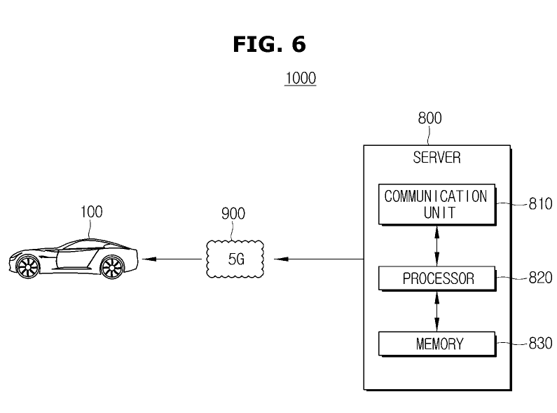

Meanwhile, the control unit 700 notifies a driver of a chance of having a vehicle accident due to an event or of a risk of a vehicle based on event-related information received from the communication unit 600 by controlling an apparatus, such as the audio system 133. The event may represent a certain situation that occurs while driving, for example, a lane violation of another vehicle or a sudden stop of the target vehicle 100, which may lead to a vehicle accident. Referring to FIGS. 6 to 9, a method of calculating information about an event by a server 800 will be described, and a method of controlling the audio system 133 based on the information about an event by the control unit 700 will be described.

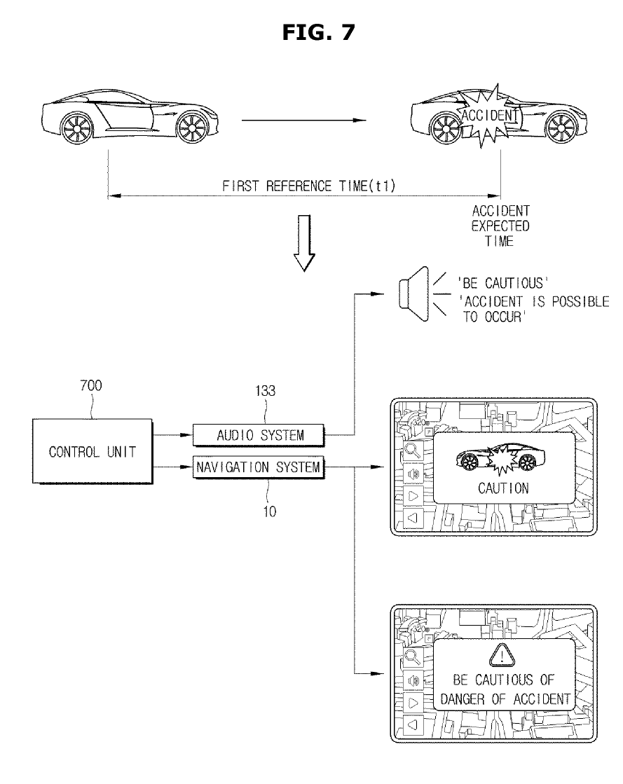

FIG. 6 is a block diagram illustrating a configuration of the server 800 in accordance with the disclosed embodiment of the present disclosure, and FIGS. 7 to 9 are conceptual diagrams illustrating a method of a vehicle notifying a driver a risk of a vehicle accident in accordance with the disclosed embodiment of the present disclosure.

Referring to FIG. 6, the server 800 includes a memory 830 in which data about an event related to a vehicle accident is stored, a communication unit 810 to communicate with the target vehicle and other vehicles, and a processor 820 to calculate information about an event of the target vehicle by using the information received from the communication unit 810.

The memory 830 may store data related to an event that has caused a vehicle accident and data related to an event that has not caused a vehicle accident but has a high chance of leading to a vehicle accident.

That is, the server 800 analyzes previous cases of a number of vehicle accidents or previous cases that have a high chance of leading to a vehicle accident, determines events closely associated with vehicle accidents, extracts data related to the determined events and stores the extracted data in the memory 830. The data related to the determined events may include image data of vehicle related to a situation in which the events have occurred, driving-related data, such as vehicle speeds, and circumstance data related to a traffic condition or weather. However, the data-related to events stored in the memory 830 is not limited thereto as long as it is used to precisely predict a chance of having a vehicle accident.

The data stored in the memory 830 may be automatically updated by an event-related data that is acquired by using information that is collected by the processor 820 from the server 800 in real time, the update may be performed in real time or periodically.

The memory 830 may include not only volatile memories, such as S-RAM and D-RAM, but also non-volatile memories, such as Read Only Memory (ROM), Erasable Programmable Read Only Memory (EPROM), and Electrically Erasable Programmable Read Only Memory (EEPROM).

The communication unit 810 may receive data transmitted from vehicles through the communication network 900 using the 3G, 4G and 5G communication methods described above. The communication unit of the server may receive data transmitted not only from the target vehicle 100, which is a target of monitoring, but also from a plurality of other vehicles belong to a predetermined range including the target vehicle 100. The communication unit 810 may be provided using an apparatus that supports the 3G, 4G and 5G communication methods that are adopted by the communication network 900. The communication unit 810 of the server 800 may receive not only data transmitted from the target vehicle 100 and other vehicles but also data transmitted from traffic infrastructures including a closed-circuit television (cctv) and weather related data provided from a meteorological agency. By using the various types of received data, the processor 820 may more precisely predict a chance of having a vehicle accident in the target vehicle 100.

The processor 820 of the server 800 determines other vehicles that are expected to arrive at the target vehicle 100 within a predetermined period of time by using data transmitted the target vehicle 100 and the plurality of other vehicles. The processor 820 compares the information transmitted from the determined other vehicles with the data stored in the memory, and generates event-related information that is transmitted to the target vehicle 100.

That is, the processor 820 determines vehicles that have an arrival time for arriving at the target vehicle 100 within a predetermined period of time, rather than vehicles existing within a predetermined distance with respect to the target vehicle 100 as vehicles to be compared and analyzed.

When vehicles to be analyzed by the processor are determined based on the distance with respect to the target vehicle 100, information about vehicles that do not exert influence on driving of the target vehicle 100 is selected as information to be analyzed. For example, a vehicle that is driving while maintaining a distance within a predetermined range from the target vehicle 100 is not considered a vehicle that may exert an influence on the driving of the target vehicle 100. That is, a vehicle, which exists within a predetermined range of distance from the target vehicle 100, may not arrive at the target vehicle 100 depending on the driving speed of the vehicle. However, even if a vehicle exists outside a predetermined range of distance from the target vehicle 100, the vehicle may rapidly arrive at the target vehicle 100 depending on the driving speed of the vehicle. Accordingly, determining a vehicle exerting influence on the target vehicle 100 based on the distance from the target vehicle 100 may cause burden of analyzing unnecessary information.

The server according to the disclosed embodiment of the present disclosure determines vehicles, as vehicles to be compared and analyzed by the processor, based on a time to be taken to arrive at the target vehicle 100, thereby more effectively determining vehicles that may exert influence on the driving of the target vehicle 100 when compared to determining to-be analyzed vehicles based on the distance from the target vehicle.

The processor 820 of the server 800 determines vehicles that have arrival time for arriving at the target vehicle 100 within a predetermined range of time as described above, determines whether an event has occurred in the target vehicle 100 by comparing data transmitted from the target vehicle 100 and the determined vehicles with the event-related data stored in the memory 830, and if it is determined that an event has occurred, a chance of having a vehicle accident due to the event is calculated.

As described above, the information transmitted from the target vehicle 100 and other vehicles may include information related to the driving of the target vehicle 100, such as the speed, the acceleration and the steering angle of the target vehicle 100, and information related to a surrounding of the vehicle 100 such as the degree to which other vehicles approach the target vehicle 100 and the speed at which other vehicles approach the target vehicle 100.

The server 900 compares the information related to the driving of the target vehicle 100, such as the speed, the acceleration and the steering angle of the target vehicle 100, with relevant travelling-related data among information about the vehicle accident-related event in the memory 830, and compares the information such as the degree to which other vehicles approach the target vehicle 100 and the speed at which other vehicles approach the target vehicle 100 with relevant information about other vehicles among information about vehicle accident related events in the memory 830.

For example, the processor 820 may compare the speed of the target vehicle 10, the acceleration of the target vehicle 100, the approach degree of other vehicles or the approach speed of other vehicles with a vehicle speed, a vehicle acceleration, an approach degree of a nearby vehicle or an approach speed of a nearby vehicle that is calculated to be included in a case that has led to a vehicle accident or has a high chance of leading to a vehicle accident. Based on a result of the comparison, the processor 820 may determine the occurrence of an event that has a chance of leading to a vehicle accident in the target vehicle 100. If it is determined that the event has occurred in the target vehicle 100, the processor 820 calculates a chance of having a vehicle accident due to the event. The processor 820 may generate a control signal such that a method of notifying a user of a chance of having a vehicle accident is varied depending on the level of the chance of having the vehicle accident if the chance of having the vehicle accident is equal to or higher than a predetermined reference.

The chance of having a vehicle accident may correspond to a time at which a vehicle accident is expected to occur. If the expected vehicle accident time is within a time interval of 2 seconds from a present point of time, it is determined that there is a high chance of having a vehicle accident when compared to when the expected vehicle accident time is within a time interval of 5 seconds from the present point of time. Similarly, if the expected vehicle accident time is within a time interval of 10 seconds from a present point of time, it is determined that there is a lower chance of having a vehicle accident when compared to when the expected vehicle accident time is within a time interval of 5 seconds from the present point of time. A remaining time until the expected vehicle accident time is large, a sufficient amount of time is ensured for a driver to perform a vehicle manipulation to avoid a vehicle accident.

For example, referring to FIG. 7, if an expected time at which a vehicle accident is likely to occur in the target vehicle 100 due to the event is calculated to a first reference time (about 10 seconds), it is determined that a driver may have a time sufficient to perform a manipulation to avoid a vehicle accident. Accordingly, in this case, referring to FIG. 7, a risk of having a vehicle accident may be notified using a speech through the audio system 133 of the target vehicle 100, or using an image through a screen of the navigation system 10.

That is, the processor 820, when a chance of having a vehicle accident due to an event is equal to or higher than a predetermined reference and a time at which a vehicle accident is expected to occur is within the first reference time, the processor 820 generates a signal that controls the audio system 133 or the navigation system 10 of the target vehicle 100 such that a user is sufficiently notified of a chance of having a vehicle accident using a speech or an image. The signal generated from the processor 820 may be transmitted to the target vehicle 100 through the communication unit 810.

Referring to FIG. 7, when the communication unit 600 of the target vehicle 100 receives the signal transmitted from the communication unit 810 of the server 800, the control unit 700 may execute an audible guide about a chance of having a vehicle accident by controlling the audio system 133 based on the received signal, and may execute a visual guide about a chance of having a vehicle accident by controlling the navigation system 10. In addition to the guide through the audio system 133 or the navigation system 10, the chance of having a vehicle accident may be guided in various functions through control of other apparatuses shown in FIG. 3. A visual guide through the display 151 of the instrument panel 150 or a tactile guide such as vibration of a steering wheel, a fastening of the seat belt 160 or vibration of the seat 170 may be performed.

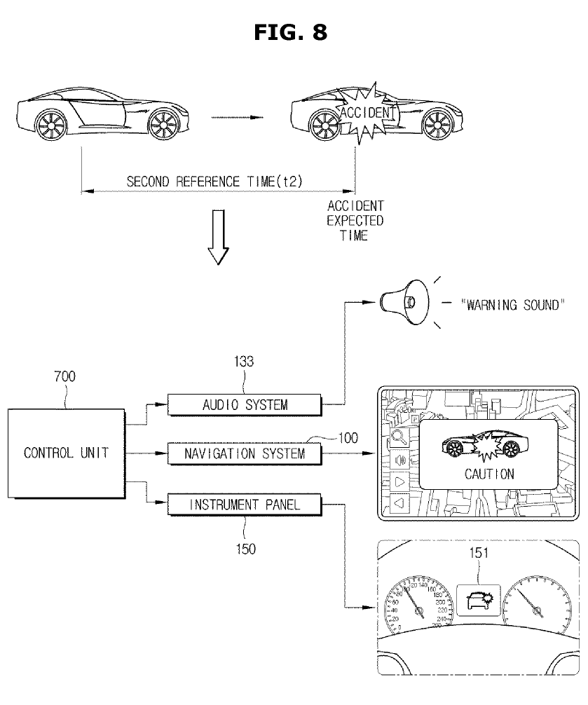

Referring to FIG. 8, if the time at which a vehicle accident is expected to occur in the target vehicle 100 due to the event being calculated to a second reference time (about 3 seconds) shorter than the first reference time, it is determined that a driver may have some time to perform a manipulation to avoid a vehicle accident. Accordingly, in this case, referring to FIG. 8, a risk of a vehicle accident may be notified in an audible manner through the audio system 133 of the vehicle 100 or in a visual manner through a screen of the navigation system 10 or the display 151 of the instrument panel. However, the time is not enough to perform a detailed guide through a speech or an image as much as FIG. 7. Accordingly, the risk of an accident is intuitively notified through a warning sound or an icon that simplifies an image of an accident.

That is, the processor 820, when a chance of having a vehicle accident due to an event is equal to or higher than a predetermined reference and a time at which a vehicle accident is expected to occur is within the second reference time shorter than the first reference time, the processor 820 generates a signal that controls the audio system 133 or the navigation system 10 of the target vehicle 100 or the instrument panel 150 such that a user is intuitively notified of a chance of having a vehicle accident through a warning sound or an icon indicating an accident. The signal generated from the processor 820 may be transmitted to the target vehicle 100 through the communication unit 801.

Referring to FIG. 8, when the communication unit 600 of the target vehicle 100 receives the signal transmitted from the communication unit 810 of the server 800, the control unit 700 may audibly notify a chance of having a vehicle accident through a warning sound by controlling the audio system 133 based on the received signal. In addition, the control unit 700 may visually notify a chance of having a vehicle through an icon indicating an accident by controlling the navigation system 10 or the instrument panel 150. In addition to the guide through the audio system 133, the navigation system 10 or the instrument panel 150, the chance of having a vehicle accident may be guided in various functions through control of other apparatuses shown in FIG. 3. For example, a tactile guide such as vibration of a steering wheel, a fastening of the seat belt 160 or vibration of the seat 170 may be performed.

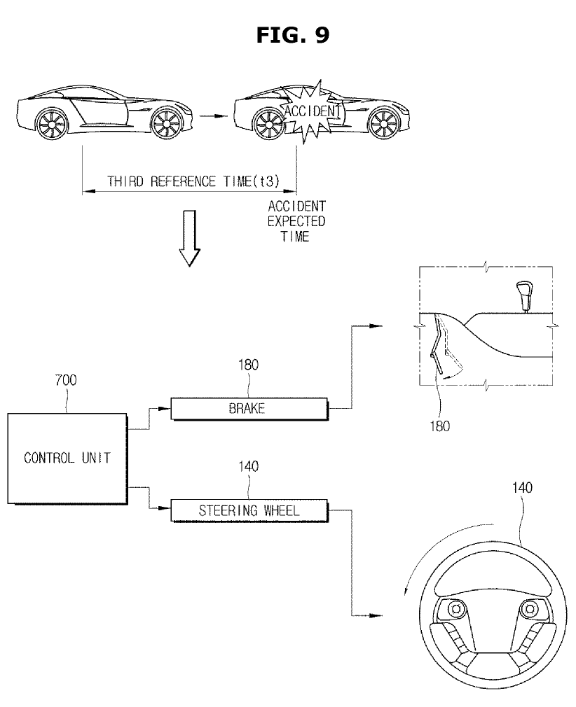

Referring to FIG. 9, if an expected time at which a vehicle accident is likely to occur in the target vehicle 100 due to the event is calculated to a third reference time (about 1 seconds) shorter than the second reference time, it is determined that a driver may be short of a time directly to perform a manipulation to avoid a vehicle accident. Accordingly, in this case, a risk of occurrence of a vehicle accident is not notified in a passive manner as in FIGS. 7 and 8, but in an active manner regardless of an intention of a driver in which the control unit 700 may directly control an operation of a brake 180 or a manipulation of the steering wheel to avoid a vehicle accident.

That is, the processor 820, when a chance of having a vehicle accident due to an event is equal to or higher than a predetermined reference and a time at which a vehicle accident is expected to occur is within the third reference time shorter than the second reference time, the processor 820 determines that a driver has difficulty in performing a manipulation to avoid an accident, and generates a signal that controls the brake 180 or the steering wheel of the target vehicle 100 such that the target vehicle 100 directly brakes the target vehicle 100 or changes the driving direction of the vehicle to avoid a collision with another vehicle without a manipulation of the driver. The signal generated from the processor 820 may be transmitted to the target vehicle 100 through the communication unit 801.

Referring to FIG. 9, when the communication unit 600 of the target vehicle 100 receives the signal transmitted from the communication unit 810 of the server 800, the control unit 700 may reduce the speed of the target vehicle 100 by controlling the brake 180 based on the received signal. In addition, the control unit 700 may change the travelling direction of the target vehicle 100 by controlling the steering wheel. Controlling of the brake 180 and the steering wheel are for illustrative purpose only. Accordingly, the apparatus to be controlled by the control unit 700 is not limited thereto as long as it is used to avoid an accident. Even if the direct control of the control unit 70 described above, a vehicle accident may occur. The control unit 700 may prevent a driver's injury due to a vehicle accident by controlling other apparatuses shown in FIG. 3 in addition to the brake 180 and the steering wheel. For example, the seat belt 160 may be tightened, the seat 170 lying down may be stood upright, or an open window may be automatically closed.

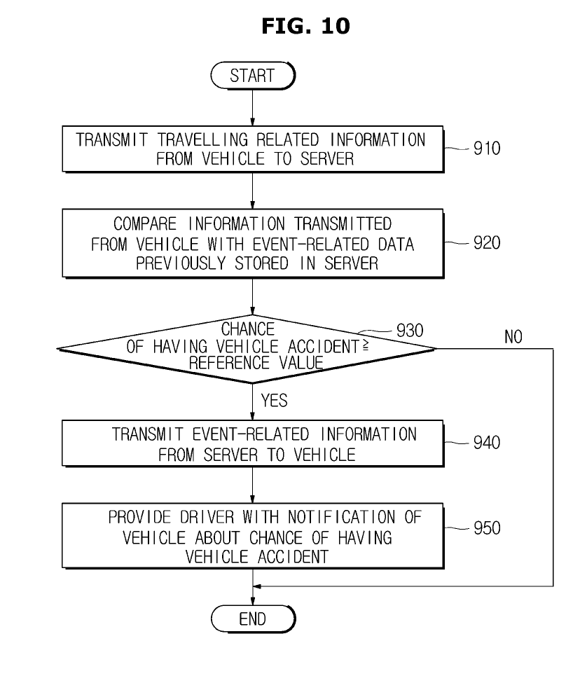

FIG. 10 is a flow chart showing a method of monitoring an event of a vehicle in accordance with the disclosed embodiment of the present disclosure.

Referring to FIG. 10, the vehicle 100 transmits travelling related information to the server 800 (S910), and the sever 800 compares the information transmitted from the vehicle 100 with a previously stored event-related data to analyze the transmitted information (S920). If it is compared and analyzed in operation 910 that a chance of having a vehicle accident is equal to or higher than a predetermined value (S930), the sever 800 transmits event-related information to the vehicle 100 (S940).

Data related to travelling of the target vehicle 100 acquired from the travelling information acquisition unit 400 of the target vehicle 100, an image acquired from the image acquisition unit 200 and information extracted from the image processing unit through a predetermined image processing may be transmitted to the communication unit 600 of the target vehicle 100. The image processing unit may detect a target object, such as another vehicle or a human, included in an image among images of an outside of the target vehicle 100 transmitted from the image acquisition unit 200, and acquire a position or a speed of the detected target object. In addition, the image processing unit may convert the image acquired from the image acquisition unit 200 into an image having a resolution that is able to be processed by the processor 820 of the server 800, or into an image having a format that is able to be processed by the processor 820 of the server 800.

The communication unit 600 may transmit data transmitted from the travelling information acquisition unit 400 and the image acquisition unit 200 to the server 800 through the communication network 900. The communication unit 600 may directly transmit the image from the image acquisition unit 200 to the server 800, or may transmit information extracted from an image being subjected to a predetermined image processing in the image processing unit to the server 800. The image transmitted from the image acquisition unit 200 may be transmitted to the server 800 together with the information transmitted from the image processing unit. The communication network 900 for transmission of data may be implemented using third generation (3G) technology and fourth generation (4G) technology that are previously commercialized, and may be implemented by using fifth generation (5G) technology for more rapid transmitting/receiving information in substantially real time. The communication unit 600 may include an apparatus that supports 3G, 4G and 5G communication methods that are adopted by the communication network 900. The communication unit 600 and the server 800 according to the disclosed embodiment may exchange information through the communication network 900 that adopts a 5G communication scheme for almost real time transmission/reception.

The processor 820 of the server 800 determines other vehicles that are expected to arrive at the target vehicle 100 within a predetermined period of time by using data transmitted the target vehicle 100 and a plurality of other vehicles. The processor 820 compares the information transmitted from the determined other vehicles with the data stored in the memory, and generates event-related information that is to be transmitted to the target vehicle 100.

The processor 820 of the server 800 determines vehicles that have arrival time for arrival at the target vehicle 100 within a predetermined range of time, determines whether an event has occurred in the target vehicle 100 by comparing data transmitted from the target vehicle 100 and the determined vehicles with the event-related data stored in the memory 830, and if it is determined that an event has occurred, calculates a chance that the event may cause a vehicle accident.

The information transmitted from the target vehicle 100 and other vehicles may include information related to the driving of the target vehicle 100, such as the speed, the acceleration and the steering angle of the target vehicle 100, and information related to a surrounding of the vehicle 100 such as the degree to which other vehicles approach the target vehicle 100 and the speed at which other vehicles approach the target vehicle 100.

The server 900 compares the information related to the driving of the target vehicle 100, such as the speed, the acceleration and the steering angle of the target vehicle 100, with relevant travelling-related data among information about the vehicle accident-related event in the memory 830, and compares information such as the degree to which other vehicles approach the target vehicle 100 and the speed at which other vehicles approach the target vehicle 100 with relevant information about other vehicles among information about vehicle accident related events in the memory 830.

For example, the processor 820 may compare the speed of the target vehicle 10, the acceleration of the target vehicle 100, the approach degree of other vehicles or the approach speed of other vehicles with a vehicle speed, a vehicle acceleration, an approach degree of a nearby vehicle or an approach speed of a nearby vehicle that is calculated to be included in a case that has led to a vehicle accident or has a high chance of leading to a vehicle accident. Based on a result of the comparison, the processor 820 may determine the occurrence of an event that has a chance of leading to a vehicle accident in the target vehicle 100. If it is determined that the event has occurred in the target vehicle 100, the processor 820 calculates a chance of having a vehicle accident due to the event. The processor 820 may generate event-related information and transmit the generated event-related information through the communication unit 810 if the calculated chance of having the vehicle accident is equal to or higher than a predetermined reference. The event-related information may include a control signal that varies a method of notifying a user of a chance of having a vehicle accident depending on the level of the chance of having the vehicle accident

When the target vehicle 100 receives the event-related information from the server, the target vehicle 100 may notify a driver of a chance of having a vehicle accident based on the received information (S950).

The chance of having a vehicle accident may correspond to a time at which a vehicle accident is expected to occur. If the expected vehicle accident time is within a time interval of 2 seconds from a present point of time, it is determined that there is a higher chance of having a vehicle accident when compared to when the expected vehicle accident time is within a time interval of 5 seconds from the present point of time. Similarly, if the expected vehicle accident time is within a time interval of 10 seconds from a present point of time, it is determined that there is a lower chance of having a vehicle accident when compared to when the expected vehicle accident is within a time interval of 5 seconds from the present point of time. A remaining time until the expected vehicle accident time is large, a sufficient amount of time is ensured for a driver to perform a vehicle manipulation to avoid a vehicle accident.

For example, referring to FIG. 7, if an expected time at which a vehicle accident is likely to occur in the target vehicle 100 due to the event is calculated to a first reference time (about 10 seconds), it is determined that a driver may have a time sufficient to perform a manipulation operation to avoid a vehicle accident. Accordingly, in this case, referring to FIG. 7, a risk of occurrence of a vehicle accident may be notified using a speech through the audio system 133 of the target vehicle 100, or may be notified using an image through a screen of the navigation system 10. That is, the processor 820, when a chance of having a vehicle accident due to an event is equal to or higher than a predetermined reference and a time at which a vehicle accident is expected to occur is within the first reference time, the processor 820 generates a signal that controls the audio system 133 or the navigation system 10 of the target vehicle 100 such that a user is sufficiently notified of a chance of having a vehicle accident using a speech or an image. The signal generated from the processor 820 may be transmitted to the target vehicle 100 through the communication unit 801. Referring to FIG. 7, when the communication unit 600 of the target vehicle 100 receives the signal transmitted from the communication unit 810 of the server 800, the control unit 700 may execute an audible guide about a chance of having a vehicle accident by controlling the audio system 133 based on the received signal, and may execute a visual guide about a chance of having a vehicle accident by controlling the navigation system 10. In addition to the guide through the audio system 133 or the navigation system 10, the chance of having a vehicle accident may be guided in various functions through control of other apparatuses shown in FIG. 3. A visual guide through the display 151 of the instrument panel 150 or a tactile guide such as vibration of a steering wheel, a fastening of the seat belt 160 or vibration of the seat 170 may be performed.

Referring to FIG. 8, if the time at which a vehicle accident is expected to occur in the target vehicle 100 due to the event being calculated to a second reference time (about 3 seconds) shorter than the first reference time, it is determined that a driver may have some time to perform a manipulation to avoid a vehicle accident. Accordingly, in this case, referring to FIG. 8, a risk of a vehicle accident may be notified in an audible manner through the audio system 133 of the vehicle 100 or in a visual manner through a screen of the navigation system 10 or the display 151 of the instrument panel. However, the time is not enough to perform a detailed guide through a speech or an image as much as FIG. 7. Accordingly, the risk of an accident is intuitively notified through a warning sound or an icon that simplifies an image of an accident. That is, the processor 820, when a chance of having a vehicle accident due to an event is equal to or higher than a predetermined reference and a time at which a vehicle accident is expected to occur is within the second reference time shorter than the first reference time, the processor 820 generates a signal that controls the audio system 133 or the navigation system 10 of the target vehicle 100 or the instrument panel 150 such that a user is intuitively notified of a chance of having a vehicle accident through a warning sound or an icon indicting an accident. The signal generated from the processor 820 may be transmitted to the target vehicle 100 through the communication unit 801. Referring to FIG. 8, when the communication unit 600 of the target vehicle 100 receives the signal transmitted from the communication unit 810 of the server 800, the control unit 700 may audibly notify a chance of having a vehicle accident through a warning sound by controlling the audio system 133 based on the received signal. In addition, the control unit 700 may visually notify a chance of having a vehicle accident through an icon indicating an accident by controlling the navigation system 10 or the instrument panel 150. In addition to the guide through the audio system 133 or the navigation system 10, the chance of having a vehicle accident may be guided in various functions through control of other apparatuses shown in FIG. 3. For example, a tactile guide such as vibration of a steering wheel, a fastening of the seat belt 160 or vibration of the seat 170 may be performed.

Referring to FIG. 9, if an expected time at which a vehicle accident is likely to occur in the target vehicle 100 due to the event is calculated to be a third reference time (about 1 seconds) shorter than the second reference time, it is determined that a driver may be short of a time directly to perform a manipulation operation to avoid a vehicle accident. Accordingly, in this case, a risk of occurrence of a vehicle accident is not notified in a passive manner as in FIGS. 7 and 8, but in an active manner regardless of an intention of a driver in which the control unit 700 may directly control an operation of the brake 180 or a manipulation of the steering wheel to avoid a vehicle accident. That is, the processor 820, when a chance of having a vehicle accident due to an event is equal to or higher than a predetermined reference and a time at which a vehicle accident is expected to occur is within the third reference time shorter than the second reference time, the processor 820 determines that a driver will have difficulty in performing a manipulation to avoid an accident, and generates a signal that controls the brake 180 or the steering wheel of the target vehicle 100 such that the target vehicle 100 directly brakes the target vehicle or changes the driving direction of the vehicle to avoid a collision with another vehicle without a manipulation of the driver. The signal generated from the processor 820 may be transmitted to the target vehicle 100 through the communication unit 801. Referring to FIG. 9, when the communication unit 600 of the target vehicle 100 receives the signal transmitted from the communication unit 810 of the server 800, the control unit 700 may reduce the speed of the target vehicle 100 by controlling the brake 180 based on the received signal. In addition, the control unit 700 may change the travelling direction of the target vehicle 100 by controlling the steering wheel 140. Controlling of the brake 180 and the steering wheel 140 are for illustrative purpose only. Accordingly, the apparatus to be controlled by the control unit 700 is not limited thereto as long as it is required to avoid an accident. Even if the direct control of the control unit 700 described above, a vehicle accident may occur. The control unit 700 may prevent a driver's injury due to a vehicle accident by controlling other apparatuses shown in FIG. 3 in addition to the brake 180 and the steering wheel. For example, the seat belt 160 may be tightened, the seat 170 lying down may be stood upright, or an open window may be automatically closed.

As is apparent from the above, the vehicle, the server and the vehicle monitoring system having the same can prevent a vehicle accident by allowing a driver to recognize a chance of having a vehicle accident due to an event that may occur during traveling of the vehicle, for example, a lane violation.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A vehicle comprising:
an image acquisition unit for acquiring an image about a surrounding of the vehicle;
a travelling information acquisition unit for acquiring travelling information about the vehicle;
a communication unit for transmitting the information acquired from the travelling information acquisition unit to a server and receiving information about an event related to the travelling of the vehicle from the server; and
a control unit for notifying a driver of a possible change in a travelling environment of the vehicle according to the event based on the information about the event received from the communication unit.

2. The vehicle of claim 1, wherein the image acquisition unit comprises a camera that is provided to acquire an image in front of the vehicle, an image behind the vehicle, an image of a left side of the vehicle and an image of a right side of the vehicle.

3. The vehicle of claim 1, wherein the traveling information acquisition unit includes at least one of a speed of the vehicle, an acceleration of the vehicle, a steering angle of the vehicle, a position of the vehicle and a distance between the vehicle and a nearby vehicle adjacent to the vehicle.

4. The vehicle of claim 1, wherein the traveling information acquisition unit comprises at least one of a speed sensor to sense a speed of the vehicle, an acceleration sensor to sense an acceleration of the vehicle, a steering angle sensor to sense a steering angle of the vehicle, a ultrasonic sensor or a radar sensor to sense an object around the vehicle, and a global positioning system (GPS) apparatus to detect a position of the vehicle.

5. The vehicle of claim 1, further comprising an image processing unit configured to acquire information about an object around the vehicle from the image acquired from the image acquisition unit.

6. The vehicle of claim 5, wherein the image processing unit acquires the information about the object around the vehicle by detecting the object around the vehicle from the image acquired from the image acquisition unit and calculating a position or a speed of the detected object.

7. The vehicle of claim 5, wherein the communication unit transmits the image acquired by the image acquisition unit and the information acquired from the image by the image processing unit.

8. The vehicle of claim 1, wherein the communication unit exchanges information with the server by using third generation (3G) communication technology, fourth generation (4G) communication technology and fifth generation (5G) communication technology.

9. The vehicle of claim 1, wherein the control unit controls at least one of an audio system, a navigation system, an instrument panel, a steering wheel, a safety belt, and a seat of the vehicle such that the driver is notified of a risk of a vehicle accident occurring due to the event in at least one manner selected from the group comprising a visual, audible and a tactile manner.

10. The vehicle of claim 1, wherein the control unit controls at least one of an audio system of the vehicle, a navigation system of the vehicle or an instrument panel of the vehicle if a time remaining until a vehicle accident expected time included in the information about the event is equal to or larger than a first reference time to notify the driver of a risk of a vehicle accident through a speed or an image so that the driver avoids the vehicle accident.

11. The vehicle of claim 10, wherein the control unit controls the audio system, the navigation system, the instrument panel, a steering wheel, a safety belt or a seat if the time remaining until the vehicle accident expected time is equal to or smaller than a second reference time that is smaller than the first reference time to notify the driver of a risk of the vehicle accident through at least one method selected from the group comprising a warning sound, a warning image and a vibration.

12. The vehicle of claim 10, wherein the control unit controls a device selected from the group consisting of a steering wheel and a brake of the vehicle if the time remaining until the vehicle accident expected time is equal to or smaller than a third reference time that is smaller than the second reference time.

13. A server comprising:
a memory for storing data about an event related to vehicle travelling;
a communication unit for receiving information transmitted from vehicles and transmitting information about the event related to vehicle travelling to a target vehicle; and
a processor for determining vehicles that arrive at the target vehicle within a predetermined time based on the information transmitted from the vehicles, comparing the information transmitted from the determined vehicles with the data stored in the memory and generating information about the event related to vehicle travelling.

14. The server of claim 13, wherein the memory stores data related to an event that has caused a vehicle accident or an event whose chance of causing a vehicle accident is equal to or higher than a predetermined reference.

15. The server of claim 14, wherein the processor determines whether the target vehicle has had an event related to a vehicle accident by comparing the data stored in the memory with the information transmitted from the determined vehicles, and calculates a chance of having a vehicle accident due to the event.

16. The server of claim 15, wherein the processor calculates a vehicle accident expected time if the chance of having a vehicle accident due to the event is equal to or higher than the predetermined reference, wherein the communication unit transmits information about the event including the vehicle accident expected time calculated by the processor to the target vehicle.

17. The server of claim 13, wherein the processor generates the information about the event related to vehicle travelling by using the information transmitted from the vehicles, information about weather and information about real time traffic conditions.

18. The server of claim 13, wherein the communication unit exchanges information with the vehicle by using third generation (3G) communication technology, fourth generation (4G) communication technology and fifth generation (5G) communication technology.

19. A vehicle monitoring system comprising:
a target vehicle for transmitting information related to vehicle travelling to a server; and
the server for receiving information transmitted from vehicles including the target vehicle, determining vehicles that arrive at the target vehicle within a predetermined time based on the information transmitted from the vehicles, comparing the information transmitted from the determined vehicles with previously stored data about an event related to vehicle travelling to generate information about the event related to vehicle travelling, and transmitting the generated information to the target vehicle,
wherein the target vehicle receives the information about the event transmitted from the server and notifies a driver of a possible change in a travelling environment of the vehicle according to the event based on the received information about the event.
